(19) United States
(12) Patent Application Publication
(10) Pub. No.: US 2025/0367961 A1
(43) Pub. Date: Dec. 4, 2025

(54) METHOD FOR EMBEDDING AT LEAST ONE MARKER IN A DECORATIVE DESIGN OF A PANEL

(71) Applicant: CFL Holding Limited, Hong Kong (HK)

(72) Inventors: Thomas Luc Martine BAERT, Sint-Martens-Latem (BE); Tom VAN POYER, Jiaxing (CN); Sven BOON, Jiaxing (CN)

(73) Assignee: CFL Holding Limited, Hong Kong (HK)

(21) Appl. No.: 19/220,773

(22) Filed: May 28, 2025

(30) Foreign Application Priority Data
May 28, 2024 (NL) 2037792

(51) Int. Cl. B44C 5/04; B44C 1/00; B44F 9/02

(52) U.S. Cl. CPC B44C 5/0446; B44C 1/00; B44F 9/02

(57) ABSTRACT

The invention relates to a method for embedding at least one marker in a decorative design of a panel, said method comprising the steps of manipulating at least one combination of pixels in at least one colour channel of at least one colour model of a decorative pattern according to at least one embedding key to form a manipulated decorative pattern; printing at least part of the manipulated decorative pattern upon at least part of an upper surface of a panel such that at least one marker is embedded within the at least one printed decorative pattern by means of at least one embedding key.

### CROSS REFERENCE TO RELATED APPLICATION

This application claims priority under 35 U.S.C. § 119 to Netherlands Patent Application No. 2037792, filed May 28, 2024, which is incorporated herein by reference in its entirety.

### FIELD OF THE INVENTION

The invention relates to a method for embedding at least one marker in a decorative design of a panel. The invention also relates to a panel which comprises at least one marker which is embedded within its decorative design.

### BACKGROUND

Decorative panels made of polymers have become increasingly popular in various industries due to their versatility, durability, and aesthetic appeal. These panels find extensive applications in interior design, architecture, and construction, contributing significantly to the visual appeal and functionality of residential, commercial, and industrial spaces. Despite their numerous advantages, the traceability, maintenance, and disposal of polymer-based decorative panels presents significant environmental and societal challenges. No singular, standard method of identifying the origin, composition, or manufacturer exists. Moreover, once installed, only the decorative top layer of the decorative panel remains visible. Over years of use, knowledge of point of purchase, model number, composition, or manufacturer are lost. Another consideration for decorative panels is that traditional methods of disposal, such as landfill or incineration, not only contribute to pollution but also waste valuable resources embodied in these materials. A contribution to this is the loss of knowledge of the material composition. As concerns about environmental sustainability continue to rise, there is a growing imperative to develop efficient recycling methods for polymer-based decorative panels, which requires an efficient way to identify the composition of the materials to be recycled.

In conclusion, there is a need for a standard identification method in decorative panels, such as decorative flooring, wall, ceiling and/or furniture panels, which does not affect the decorative function of the panel, but which remains usable and visible during its lifetime. A known way to identify products is the use of a steganography technique. Steganography primarily involves embedding hidden information within images. This technology aims to conceal data within the visual elements of the design. Preferably, such data is embedded within the design such that they are imperceptible to the naked eye but can be recognized by specialized software. Despite advancements in steganography techniques, there remain several technological challenges that the proposed invention aims to address such as ensuring a good visual quality of the panel and integration of the steganography within the conventional production process.

In the current state of the art, while there are general descriptions of steganography techniques for embedding hidden information in digital designs, there is a lack of detailed and specific guidance on how to effectively implement these methods, particularly in the context of decorative panels. The precise approach to manipulate the colour space to embed data without negatively impacting the aesthetics of the design remains unclear. Moreover, existing literature fails to provide specific usage scenarios that demonstrate any practical benefits to customers and society in terms of digital interactivity and seamless integration with traceability, compliance, quality, production and/or end-of-life processes.

Hence, it is a goal of the invention to overcome at least part of the current limitations and provide a more secure and efficient solution for data embedding in decorative panels.

### SUMMARY OF THE INVENTION

The invention provides thereto a method for embedding at least one marker in a decorative design or decorative pattern of a panel or a method for producing a decorative building panel comprising at least one embedded marker, comprising the steps of:
providing at least one panel comprising an upper surface and a bottom surface;
providing at least one decorative pattern, in particular a predefined decorative pattern, which is to be printed upon at least part of the upper surface of at least one panel, wherein said decorative pattern comprises at least one colour model and/or is conducted by using at least one colour model, said colour model comprising multiple colour channels;
optionally manipulating at least one combination of pixels representing at least one readable code in at least one colour channel of at least one colour model of the said decorative pattern to form a manipulated decorative pattern according to at least one embedding key, wherein the at least one combination of pixels forms at least one marker; and/or
printing at least part of the (manipulated) decorative pattern upon at least part of the upper surface of the at least one panel, in particular wherein and/or such that the at least one marker is embedded within the at least one printed manipulated decorative pattern by means of at least one embedding key.

The at least one embedding key preferably defines at least one predefined colour shift in at least one colour channel in at least one colour model to form the at least one marker.

The invention also relates to a method for embedding at least one marker in a decorative design or decorative pattern of a panel, comprising the steps of providing at least one panel comprising an upper surface and a bottom surface, providing at least one decorative pattern, in particular a predefined decorative pattern, which is to be printed upon at least part of the upper surface of at least one panel, wherein said at least one decorative pattern comprises at least one colour model and/or is conducted by using at least one colour model, said colour model comprising multiple colour channels, and printing at least part of the at least one decorative pattern upon at least part of the upper surface of at least one panel,
wherein the at least one marker is embedded within at least one printed decorative pattern in particular by means of at least one embedding key, more in particular wherein the at least one embedding key defines at least one value change in at least one colour channel in at least one colour model.

### BRIEF DESCRIPTION OF THE FIGURES

The invention will be further elucidated by means of non-limiting exemplary embodiments illustrated in the following figure, in which:

FIG. 1 shows a schematic example of applying an embodiment of the method according to the present invention.

FIG. 2 shows a second schematic example a of applying an embodiment of the method according to the present invention.

FIG. 3 shows how the embedded markers according to the invention can be applied in practice.

### DETAILED DESCRIPTION

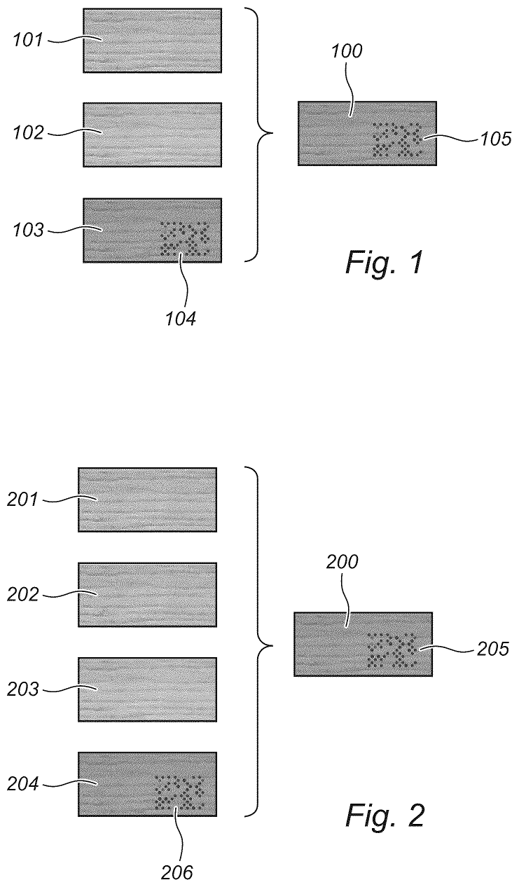

FIG. 1 shows a schematic representation of an example of applying an embodiment of a method according to the present invention. The figure shows the decorative pattern of a panel 100 which is defined by a colour model comprising multiple colour channels 101, 102, 103. The figure shows that at least one embedding key 104 is included in a colour channel 103. The embedding key 104 defines a value change in the colour channel 103. Upon printing, as defined the figure, the embedding key 104 results in that a marker 105 is embedded within the printed decorative pattern of the panel 100. The figure visualizes the embedded marker 105. In practise, the method enables that Delta E between an average colour of the marker and an average colour of at least one region of the decorative pattern adjacent to the marker so small such that a high level of visual similarity in colours is achieved.

FIG. 2 shows a second schematic example a of applying an embodiment of the method according to the present invention. The figure shows the decorative pattern of a panel 200 which is defined by a colour model comprising multiple colour channels 201, 202, 203, 204, in particular representing cyan 201, magenta 202, yellow 203 and black 204. The figure shows that at least one embedding key 204 is included in a colour channel 204. The embedding key 206 defines a value change in the colour channel 204. Upon printing, as defined the figure, the embedding key 206 results in that a marker 205 is embedded within the printed decorative pattern of the panel 200. The figure visualizes the embedded marker 205. In the shown embodiment, the embedding key 206 is only applied in the black channel 204.

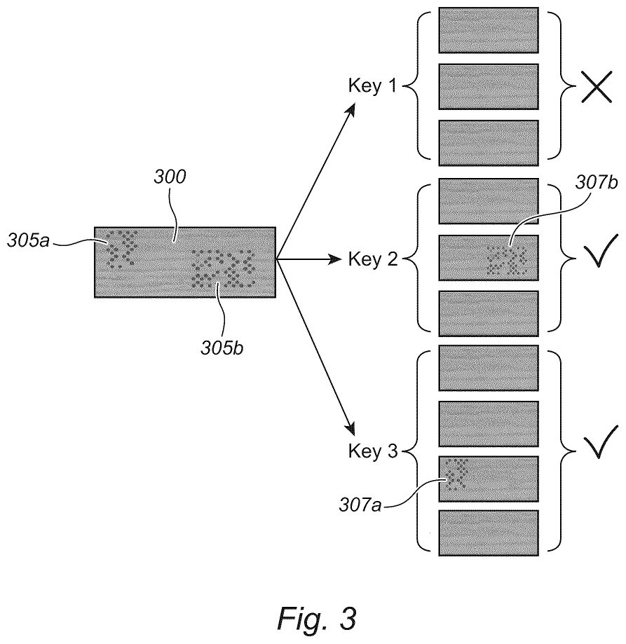

FIG. 3 shows in a schematic representation how the embedded markers according to the invention can be applied in practice. The figure shows a panel 300 which comprises multiple embedded markers 305a, 305b. Upon scanning of the panel, at least one processor will identify the presence of at least one marker in at least one colour channel of one colour model according to predefined keys, respectively key 1, key 2 and key 3. This can for example be done by a user taking a picture of at least part of the surface of the panel 300. Despite the embedded markers 305a, 305b being clearly shown in the figure, it is conceivable that the markers 305a, 305b are not visible with the naked eye in practice. Subsequently, after the scanning step, the hidden codes 307a, 307b can be detected by a user. The codes can be detected if the markers 305a, 305b are scanned by visual imaging means which comprises a filter configured to focus on the colour of at least one altered colour channel. The figure shown that in key 1 there is no code detected. In respectively key 2 and key 3, codes are detected. This may for example result in an action and/or in the provision of information to the user. It is conceivable that the at least one processor will utilize n keys wherein n is an integer larger than 1. For example, it is conceivable that the at least one processor will utilize 10 keys to identify up to 10 embedded markers in the decorative surface of the panel.

The method according to the present invention provides a (n analogous) way of embedding at least one marker within the decorative pattern of a (decorative) panel and a method of forming the said marker. Also, a method to provide a way to embed at least one analogous marker within the decorative pattern of a decorative panel can be meant. By using at least one embedding key to form the at least one marker by manipulating at least one plurality of pixels representing at least one readable code in at least one colour channel of at least one colour model according to at least one embedding key, said at least one embedding key defining at least one predefined colour shift in at least one colour channel in at least one colour mode. With at least one plurality of pixels or plurality of dots also a combination of pixels can be meant. The step of manipulating at least one combination of pixels in at least one colour channel of the at least one colour model of said decorative pattern can be done based upon at least one embedding key. The printing of the manipulated decorative pattern results in the provision of an embedded marker within the decorative design of the panel.

In some embodiments, by using at least one embedding key which enables that at least one value change in at least one colour channel in at least one colour model is achieved, at least one marker can be embedded within at least one printed decorative pattern without the need to adapt the (digital) predetermined decorative pattern as such. The method according to the invention therefore provides a more secure and efficient solution for data embedding in decorative panels. The method enables that at least one marker can be embedded within the printed decorative pattern while maintaining a low Delta E value between the colour of the marker and the (initial) colour of the decorative print.

Within the context of the present invention, when it is referred to a marker also a colour marker, an identifier, a unique identifier and/or an interactive marker could be meant. The method according to the invention could also be referred to as a method for producing a decorative panel, a decorative film and/or a decorative sheet. The panel according to the invention could for example be a floor panel, a wall panel, a ceiling panel, a furniture panel or a building panel.

The method according to the invention basically enables to combine effective data embedding for tangible customer use cases. Embedding at least one marker in the decorative pattern of a panel can streamline production processes by enabling automated tracking and sorting. For instance, each panel can be assigned at least one marker comprising a unique ID, allowing for real-time monitoring of production stages, error detection, and/or quality control. This information can be linked to a database, providing insights into production efficiency, identifying bottlenecks, and facilitating just-in-time inventory management. In regulated industries, the at least one marker can serve as an identifier for traceability and compliance purposes. By linking the marker to a database, authorities can verify the authenticity, origin, and compliance status of the panels which is non-falsifiable as it is embedded. This is particularly useful for products subject to environmental regulations, safety standards, or import/export restrictions. It is also possible that at least one marker is used to provide installation assistance to end-users. By scanning the panel with a smartphone or specialized tool, users can access digital features such as an installation manual, step-by-step instructions, or even augmented reality (AR) overlays guiding them through the process. This improves the user experience and reduces the likelihood of installation errors. Further, the marker can offer ongoing support during the product's lifetime. Scanning the panel can unlock maintenance tips, care instructions, or warranty information. Additionally, it can suggest complementary products, accessories, or replacement parts, enhancing customer satisfaction and promoting upselling opportunities. It is conceivable that the marker is an interactive marker such as an augmented reality (AR) marker. Upon reaching the end of the usable life of the panel, the marker may further facilitate responsible disposal or recycling. By providing recyclers with a unique identifier, they can access information about the panel's materials, composition, and recommended recycling procedures. This ensures that waste is managed properly, reducing environmental impact and supporting circular economy initiatives.

In a possible embodiment, at least one embedding key provides a means for adjusting or manipulating at least one combination of pixels in at least one colour channel of the at least one colour model of said decorative pattern to form a manipulated decorative pattern. At least a part of the manipulated decorative pattern is printed upon at least part of the upper surface of the at least one panel such that at least one marker is embedded within the at least one printed decorative pattern by means of at least one embedding key, wherein the at least one embedding key defines at least one predefined colour shift in at least one colour channel of said at least one colour model.

In some preferred embodiment, the at least one embedding key provides a means for adjusting at least a portion of at least one colour channel of at least one colour model in at least one predetermined point and/or region such that at least one marker is embedded within the printed decorative pattern. The positioning of at least one marker can be determined based on the predetermined decorative pattern of the panel.

In a preferred embodiment, the at least one embedding key is used to embed at least one marker in at least a portion of at least one colour channel of at least one colour model of the decorative pattern prior to printing the said decorative pattern.

In a beneficial embodiment, at least one marker comprises a plurality of dots and/or pixels, in particular oversized pixels. At least one marker comprising a plurality of dots and/or (oversized) pixels has several advantages. The simplicity of the form is beneficial as this is relatively easy to implement in at least one colour channel. Further, dots and/or pixels would be easily recognizable by a scanning device. Further, such markers facilitate increased information density, allowing for the representation of relatively large amounts of information in a compact format. In computer vision and augmented reality contexts, the use of a plurality of dots and/or pixels enables more accurate tracking and localization of the markers, enhancing overall system performance. It is for example possible that the size of at least one dot and/or pixel and preferably of multiple dots and/or pixels is at least 1×1 mm, preferably at least 2×2 mm. It is also possible that the size of at least one dot and/or pixel and preferably of multiple dots and/or pixels is at most 5×5 mm, preferably at least 4×4 mm. Possibly each dot and/or pixel is at least 1×1 mm. Preferably, the surface area defined by at least one dot and/or pixel and preferably of multiple dots and/or pixels is at least 1 mm², more preferably at least 2 mm², even more preferably at least 3 mm². It is also conceivable that the surface area defined by at least one dot and/or pixel and preferably of multiple dots and/or pixels is at most 10 mm², more preferably at most 7.5 mm², even more preferably at most 5 mm².

The surface area defined by at least one marker is preferably at least 5 mm², more preferably at least 10 mm², even more preferably at least 20 mm², most preferably at least 40 mm². It is for example possible that the surface area defined by at least one marker is about 10×10 mm or 20×20 mm. The surface area defined by at least one marker can be at most 75 mm², or at most 50 mm².

The method may further comprise the step of determining at least one point and/or region within at least one colour channel of at least one colour model of the decorative pattern for applying at least one marker and providing at least one embedding key using at least one neural network. This has the advantage of applying the embedded marker while producing without compromising on production speed and obviating the need to store the image on a storage device. It is conceivable that this is achieved by providing at least one processor configured to identify a suitable region and/or applying at least one marker to at least one colour channel of at least one colour model. The at least one processor might be a SoC (system on a chip).

It is conceivable that the said embedding key corresponds to the at least one determined point and/or region within the decorative pattern. It is for example possible that at least one point and/or region where at least one marker is to be positioned is determined based on the visual design of the decorative pattern. It is also possible that at least one point and/or region is based on the colour scheme of the decorative pattern. It is for example conceivable that the visual design is a wood design and that at least one position and/or region is determined in the area of at least one visual characteristic of the wood design.

It is possible that during the printing step, at least one colour value of at least one colour channel of at least one colour model is adapted based on the at least one embedding key. It is for example possible that at least one colour value of at least one colour channel of at least one colour model is increased or decreased based on the at least one embedding key. It is also possible that multiple colour values of at least one colour channel of at least one colour model are adapted based on the at least one embedding key and/or that at least one colour value of multiple colour channels of at least one colour model is adapted based on the at least one embedding key. The method thus enables the provision of a plurality of markers, possibly in a plurality of colour channels. Embedding at least one marker in at least one colour channel provides an effective way to manipulate a design whilst controlling the visual quality of the final aesthetic appearance of the product.

It is also possible that the method comprises at least one marker in at least one colour channel of at least one colour model prior to the printing step. It is also possible that multiple markers are embedded within multiple colour channels of the printed decorative pattern, wherein preferably at least two markers are positioned at a distance from each other. If a plurality of markers is provided, said markers may be organized hierarchically, with primary and secondary markers serving different purposes. It is also conceivable that the data associated to the primary marker is different from the data associated to the secondary marker. Primary markers might be used for broad identification or traceability, while secondary markers could contain more specific information, such as installation instructions or maintenance guidelines. The hierarchical structure allows for a modular approach to data storage and retrieval.

There are several colour models which could be applied in practice, such as but not limited to: RGB (Red, Green, Blue), CMYK (Cyan, Magenta, Yellow, Key/Black), HSL/HSV (Hue, Saturation, Lightness/Value), Lab (CIELAB), and/or YUV/YCbCr. For the decorative pattern applied in a method and/or panel according to the present invention, it is conceivable that multiple colour models are involved. In relation to at least one colour model, a colour space defines an implementation or instantiation of such colour model. The colour model defines a logical representation of how colours are created or perceived, for example in the form of a mathematical model or conceptual framework. Hence, a colour space can be a concrete realization of at least one colour model within a particular context or application. It specifies the range of colours that can be represented within that model, along with the precise coordinates or values needed to represent each colour. For example, within the RGB colour model, there are different colour spaces such as sRGB, Adobe RGB, and ProPhoto RGB, each with its own gamut of reproducible colours and specific parameters for representing those colours numerically. Hence, where a colour model provides a conceptual framework for understanding colours, a colour space is a practical implementation of that model tailored to specific devices, software applications, or industries. It is conceivable that at least one embedding key is included in at least one colour space prior to the printing step such that at least one marker is embedded within the printed decorative pattern.

By utilizing one or more colour models, such as RGB, CMYK, or LAB, multiple markers can be embedded without significantly affecting the visual quality of the design. Within each colour models, specific colour channels can be targeted for embedding additional markers. For example, in the RGB model, the red, green, and blue channels can be independently manipulated or synergistically manipulated to form the marker such that at least a first portion of the said marker can be embedded in a first channel and at least a portion of a second portion of the marker is embedded in a second channel, wherein the first portion and the second portion form a single marker. In some embodiments, a first channel comprises a first marker and a second channel comprises a second marker, each comprising a different set of data. It is also conceivable that a channel comprises at least one marker in different portions or areas of the said channel. Similarly, in the CMYK space, cyan, magenta, yellow, and black channels can be used. By controlling the colour shifts in these channels, multiple markers can coexist without noticeable changes to the overall appearance of the design.

Preferably, at least one colour channel of at least one colour model is adjusted such that the Delta E between an average colour of at least one marker and an average colour of at least one region adjacent to said at least one marker is smaller than 15, preferably smaller than 6, more preferably smaller than 2. This enables that a high level of visual similarity between the original design and the design comprising at least one embedded marker is achieved. This is very beneficial for the aesthetics of the panel. Delta E (ΔE) is a metric used to quantify the difference between two colours. It measures the perceptual difference in colour between a reference colour and a sample colour. For the present invention, an average colour of at least one region adjacent to said at least one marker can be the reference colour whereas the average colour of at least one marker can be the sample colour. Delta E can be determined via an internationally accepted formula or standard, such as Delta E 1976 (CIE76), Delta E 1994 (CIE94), Delta E 2000 (CIEDE2000), or the like. These formulas consider factors like the human visual system's sensitivity to different colours and/or the geometry of a colour space. Delta E values thus indicate how much two colours differ from each other. A Delta E value of 0 means the colours are identical, while higher Delta E values indicate greater perceptual differences. Typically, Delta E values below 1 are considered imperceptible to the human eye, values between 1 and 2 are considered acceptable in most applications, and values above 2 indicate noticeable differences in colour. For the present invention, it is for example possible that at least one colour channel of at least one colour model is adjusted such that the Delta E between an average colour of at least one marker and an average colour of at least one region adjacent to said at least one marker is the range of 0.5 to 15, preferably in the range of 0.75 to 6, more preferably in the range of 1 to 2. It is for example possible that the average colour of at least one marker is defined over a surface area defined by said at least one marker and/or that the average colour of at least one region adjacent to said at least one marker is at least equal in size to, or larger than, the surface area defined by said at least one marker. It is also conceivable that at least one region adjacent to at least one marker substantially surrounds the at least one marker. In this way, the colour difference can be determined such that a reliable result is achieved.

In a possible embodiment, at least one panel comprises at least one chamfer, and at least one marker can be positioned upon the at least one chamfer. It is for example that an upper surface of the panel comprises at least one, and preferably at least two chamfers or bevels positioned at a distance from at least one lateral edge of the panel. This can provide an embodiment of the panel that has a visual appearance resembling multiple panels. The edges of the panel can for example feature an optional chamfer or bevel to enhance the visual effect of real material such as wood, real stone, or ceramic, simulating a grout or mortar of a tile, or the chiselled or milled edge of a wood panel. Possibly, the bevels of two adjacent panels having a substantially square shape define a grout, for example an imitation grout.

It is possible that at least one embedding key comprises a set of guidelines or instructions that dictate which colour shifts to apply within the decorative pattern. It is conceivable that at least one embedding key is configured to process an image of at least part of the predefined decorative pattern. The said embedding key provides an overview or summary of which colour shifts to apply to produce the marker. The overall embedding process may include one or more of the following steps: 1) providing at least one image representing an aesthetic visual; 2) analysing said image's colour characteristics, such as hue, saturation, and brightness; 3) identifying at least one region where colour shifts can be introduced without significantly altering the overall appearance of the image, such as specific regions, colour gradients, or patterns that can tolerate minor changes without drawing attention; 4) providing at least one embedding key; 5) forming the at least one marker by manipulating at least one plurality of pixels representing at least one readable code in at least one colour channel of at least one colour model according to at least one embedding key, said at least one embedding key defining at least one predefined colour shift in at least one colour channel in at least one colour mode; 6) physically providing the image on a panel by means of printing, preferably digital printing, 7) verifying the accuracy of the marker by means of said at least one embedding key. It is conceivable the identification step, or one or more further steps, is/are achieved by at least one machine learning model.

A single universal embedding key can be used to embed a marker or a unique identifier across various designs. It is also conceivable that a plurality of markers is to be embedded in a single decorative pattern by employing a plurality of embedding keys, possibly each configured to adjust a different colour channel and/or to utilize a different colour space.

Optionally, the method may include applying a surface structure onto at least part of the upper surface of at least one panel. This could for example be done by guiding the panel over at least one roller, in particular at least one embossing roller and/or by guiding the panel through a set of rollers comprising at least one embossing roller. It is conceivable that the surface structure can be applied onto at least part of the at least one panel using subtractive and/or additive manufacturing methods.

It is possible that at least one marker comprises a QR code, a data matrix, an Aztec code, a MaxiCode and/or a DotCode. At least one of these examples or a combination of at least two could be used. The type of marker to apply depends on the intended goal of the marker. QR codes benefit of being widely recognized, where data matrix codes are typically relatively compact and benefit of a high data storage capacity. Aztec codes also provide high data density where MaxiCodes offer high-speed, omnidirectional scanning capabilities. DotCodes are known for their resilience to damage and high data capacity due to their high durability. Possibly, at least one marker forms an isolated pattern alignment or a grid or diagonal pattern alignment.

The method may further comprise the step of determining the shape of at least one marker based upon the visual design of the decorative pattern. It is for example possible that at least part of the shape of at least one marker mimics part of the visual design of the decorative pattern. It is conceivable that at least part of the decorative pattern comprises a wood pattern and that at least one marker is located adjacent to at least one design characteristic, such as at least one growth ring and/or at least one knot or wherein at least one marker is located at least partially within at least one design characteristic such as at least one growth ring and/or at least one knot. In line with this, it is possible that at least part of the decorative pattern comprises a decorative pattern comprising a plurality of design characteristics, wherein at least one marker is located adjacent to at least one design characteristic or wherein at least one marker is located at least partially within at least one design characteristic. Non-limiting examples of decorative pattern which could be included in the method and/or panel according to the present invention are a wood pattern, stone pattern, ceramic pattern, marble pattern, brick pattern and/or granite pattern. It is also possible that the decorative pattern comprises an art pattern.

At least part of the decorative pattern is preferably printed upon at least part of the upper surface of at least one panel via continuous printing, digital printing, rotogravure printing and/or combination thereof. Such printing method enable that at least one colour channel of at least one colour channel is adapted.

Since the method according to the present invention in particular enables that at least one marker is embedded within the decorative pattern of a (decorative) panel in an analogous way, the predefined or predetermined decorative pattern may be unaltered. Hence it is possible that the method includes that the predefined decorative pattern is unaltered. In particular, the predefined (digital) decorative pattern which is applied is unaltered. This is beneficial as it enables that the no amendments have to be made to the primary design. Hence, the efficiency and quality of the original production process will not be negatively affected.

At least one marker is preferably configured such that said at least one marker is detectable with visual imaging means by applying at least one embedding key to identify the pattern of the at least one marker and by analysing the colour shifts in at least one colour channel as defined by the embedding key. It is for example possible that at least one marker is detectable by scanning the panel with a smartphone, home automation equipment, an (industrial) camera and/or a specialized tool, which applies such embedding key for detecting the marker, or which comprises an app or software which comprises an embedding key or which utilizes a detection and/or decryption means for at least detecting the said marker.

Hence, the invention can also be considered to be related to a method for identifying and/or processing at least one embedded information in a decorative pattern of a panel. The method may comprise the processing of visual data by means of a processor to extract information and/or trigger one or more desired actions. The method for example assumes that the at least one marker has been previously embedded using the present invention. It is conceivable that the method comprises one or more of the following steps: 1) acquiring at least one image comprising at least one marker, which is in particular the physical or digital representation of the decorative panel with the hidden marker, by means of at least one sensor, 2) optionally preprocessing the at least one image to remove any noise or artifacts that might interfere with the marker detection, comprising resizing, denoising, and/or colour correction, 3) detecting at least one marker by means of the processor, applying at least one embedding key to identify the pattern of at least one marker within the image, in particular by analysing the colour shifts in the colour channels as defined by the embedding key, 4) extracting the data sequence by means of the processor, converting the data into a unique identifier, a URL, or any other encoded information, 5) mapping the extracted data to the corresponding action or set of operations in a database, associating the marker with the appropriate response or instruction, and/or 6) enabling that at least one or more operations will be executed, for example via displaying an installation manual and/or video on a connected device, providing maintenance tips, warranty information and/or product recommendations, activating a warranty registration process, redirecting to a recycling information page, triggering a personalized marketing campaign, feeding back information on the user, providing technical data on product composition, origin, traceability, and/or compliance data. The processor may be responsible for one or more of the above-described steps. The processor may further log the interaction, including the marker identification, performed operations, and any user feedback. It is conceivable that this data is further used for analytics, performance optimization, and troubleshooting. The processor may therefore identify and process an interactive marker embedded in said at least one design and execute one or more desired actions. This allows to provide an interactive experience for the user. The key to this process lies in the accurate detection of the marker and the correct interpretation of the extracted data, which is facilitated by the at least one standard embedding key.

The method may further comprise the step of scanning at least one marker via visual imaging means which comprises a filter configured to focus on the colour of at least one altered colour channel. Subsequently, the method may comprise the step of processing at least one detected marker.

The method can also include the step of profiling and/or edging at least one side edge of at least one laminated panel. It is for example imaginable that the step includes the provision of coupling elements or coupling parts, preferably complementary coupling elements or coupling parts. The core layer may optionally comprise complementary coupling parts. The core could, for example, comprise at least one pair of opposite side edges which are provided with complementary coupling parts. The complementary coupling parts, if applied, are typically configured for interconnecting adjacent panels. Typically, at least one pair of opposite side edges of the core layer is provided with complementary coupling parts. For example, the core layer comprises at least one pair of complementary coupling parts on at least two of its opposite side edges. Said coupling parts may for example be interlocking coupling parts configured for mutual coupling of adjacent panels in multiple directions. Preferably, said interlocking coupling parts provide locking in both horizontal and vertical directions. Any suitable interlocking coupling parts as known in the art could be applied. For example, said interlocking coupling parts may be in the form of complementary tongue and groove, male and female receiving parts, a projecting strip, and a recess configured to receive said strip or any other suitable form. It is conceivable the complementary coupling parts require a downward scissoring motion when engaging or are locked together by means of a horizontal movement. It is further conceivable that the interconnecting coupling mechanism comprise a tongue and a groove wherein the tongue is provided on one side edge of one pair of opposite side edges, and the groove is provided on the other side edge, or an adjacent side relative to that of the tongue, of the same pair of opposite side edges.

The invention relates to a method for embedding at least one marker in a decorative design or pattern of a panel by using at least one embedding key within at least one colour channel applied to the decorative pattern of the panel. The invention also relates to a method for embedding at least one marker in a decorative design of a panel, comprising the steps of providing at least one panel comprising an upper surface and a bottom surface, providing at least one predefined decorative pattern which is to be printed upon at least part of the upper surface of at least one panel, wherein said decorative pattern comprises at least one colour model and/or said decorative pattern is conducted by using at least one colour model, said colour model comprising multiple colour channels, printing at least part of the decorative pattern upon at least part of the upper surface of at least one panel, wherein at least one embedding key is included in at least one colour channel of at least one colour model prior to the printing step such that at least one marker is embedded within the printed decorative pattern. This embodiment could be applied in combination with any of the described embodiment of the method according to the invention.

The invention further relates to a panel, in particular a decorative panel, comprising an upper surface and a bottom surface, wherein at least part of the upper surface comprises at least one decorative pattern, wherein at least one marker is embedded within the decorative pattern, and preferably wherein the colour difference Delta E between an average colour of at least one marker and an average colour of at least one region adjacent to said at least one marker is smaller than 15, preferably smaller than 6, more preferably smaller than 2.

The panel can be produced or made via the method according to the present invention. Any of the embodiment and examples given for the method according to the present invention also apply to the panel according to the present invention.

The region applied to determine the average colour of at least part of the decorative pattern is preferably the same size or bigger than surface area applied to determine the average colour of at least one marker. For the present invention, it is for example possible that Delta E of an average colour of at least one marker and an average colour of at least one region adjacent to said at least one marker is the range of 0.5 to 15, preferably in the range of 0.75 to 6, more preferably in the range of 1 to 2.

The average colour of at least one marker is defined over a surface area defined by said at least one marker and wherein the average colour of at least one region adjacent to said at least one marker is at least equal in size as the surface area defined by said at least one marker. Possibly, the at least one region adjacent to said at least one marker substantially surrounds the at least one marker. In a possible embodiment, at least one marker comprises a plurality of dots and/or pixels, in particular oversized pixels. The size of at least one dot and/or pixel and preferably of multiple dots and/or pixels is for example at least 1×1 mm, preferably at least 2×2 mm. It is also possible that the surface area defined by at least one dot and/or pixel and preferably of multiple dots and/or pixels is at least 1 mm². Yet in another possible embodiment, the surface area defined by at least one marker is at least 10 mm², preferably at least 20 mm², more preferably at least 40 mm².

Multiple markers can be embedded within the decorative pattern, wherein at least two markers are positioned at a distance from each other. At least one marker may comprise a QR code, a data matrix, an Aztec code, a MaxiCode and/or a DotCode. The panel may comprise at least one chamfer, and wherein at least one marker is positioned upon the at least one chamfer. In a non-limiting example, at least part of the decorative pattern comprises a wood pattern and at least one marker is located adjacent to at least one growth ring and/or at least one knot or wherein at least one marker is located at least partially within at least one growth ring and/or at least one knot.

Preferably, at least one marker is configured such that said at least one marker is detectable with visual imaging means by applying at least one embedding key to identify the pattern of at least one marker within the image and by analysing the colour shifts in the colour channels as defined by the embedding key. In another embodiment, the visual imaging means comprises a filter configured to focus on the colour of the at least one altered colour channel. This then enables the marker detection and/or analysis of the colour shifts in the colour channels.

### CLAUSES

1. Method for producing a decorative building panel comprising at least one embedded marker, comprising the steps of:
providing at least one panel comprising an upper surface and a bottom surface;
providing at least one decorative pattern comprising at least one colour model, said colour model comprising a plurality of colour channels;
manipulating at least one combination of pixels \in at least one colour channel of the at least one colour model of said decorative pattern according to at least one embedding key to form a manipulated decorative pattern, wherein the at least one combination of pixels forms at least one marker;
printing at least part of the manipulated decorative pattern upon at least part of the upper surface of the at least one panel such that at least one marker is embedded within the at least one printed decorative pattern by means of at least one embedding key;
   wherein the at least one embedding key defines at least one predefined colour shift in at least one colour channel of said at least one colour model.
   2. Method according to clause 1, wherein the at least one embedding key comprises instructions for manipulating said at least one combination of pixels in at least one colour channel of the at least one colour model in at least one predetermined region such that the at least one marker is embedded within the printed manipulated decorative pattern.
   3. Method according to clause 1 or clause 2, comprising the step of determining at least one region within the decorative pattern for applying said at least one marker preferably via at least one neural network.
   4. Method according to any of the previous clauses, wherein at least one marker is a colour marker.
   5. Method according to any of the previous clauses, wherein at least one colour value of at least one colour channel of at least one colour model of said at least one combination of pixels is increased or decreased based on the at least one embedding key.
   6. Method according to any of the previous clauses, wherein said at least one combination of pixels of at least one colour channel of at least one colour model is adjusted such that the Delta E between an average colour of at least one marker and an average colour of at least one region adjacent to said at least one marker is smaller than 15, preferably smaller than 6, more preferably smaller than 2.
   7. Method according to clause 6, wherein the average colour of at least one marker is defined over a surface area defined by said at least one marker and wherein the average colour of at least one region adjacent to said at least one marker is at least equal in size as the surface area defined by said at least one marker.
   8. Method according to any of the previous clauses, wherein at least one marker comprises a plurality of dots and/or pixels, in particular oversized pixels.
   9. Method according to clause 8, wherein the size of at least one dot and/or pixel and preferably of multiple dots and/or pixels is at least 1×1 mm.
   10. Method according to clause 8 and/or 9, wherein the surface area defined by at least one dot and/or pixel and preferably of multiple dots and/or pixels is at least 1 mm².
   11. Method according to any of the previous clauses, wherein the surface area defined by at least one marker is at least 10 mm², preferably at least 20 mm², more preferably at least 40 mm².
   12. Method according to any of the previous clauses, wherein at least one panel comprises at least one chamfer, and wherein at least one marker is positioned upon the at least one chamfer.
   13. Method according to any of the previous clauses, wherein at least one marker comprises a QR code, a data matrix, an Aztec code, a MaxiCode, and/or a DotCode.
   14. Method according to any of the previous clauses, comprising the step of determining the shape of at least one marker based upon the visual design of the decorative pattern.
   15. Method according to any of the previous clauses, wherein at least part of the decorative pattern comprises a wood pattern and wherein at least one marker is located adjacent to at least one growth ring and/or at least one knot or wherein at least one marker is located at least partially within at least one growth ring and/or at least one knot.
   16. Method according to any of the previous clauses, wherein at least part of the decorative pattern is printed upon at least part of the upper surface of at least one panel via continuous printing, digital printing, rotogravure printing, and/or combination thereof.
   17. Method according to any of the previous clauses, wherein the predefined decorative pattern is unaltered.
   18. Method according to any of the previous clauses, wherein at least one marker is configured such that said at least one marker is detectable with visual imaging means which comprises a filter configured to focus on the colour of the at least one altered colour channel.
   19. Method according to any of the previous clauses, wherein at least one embedding key is included in at least a portion of at least one colour channel of at least one colour model prior to the printing step such that multiple markers are embedded within the printed decorative pattern, wherein at least two markers are positioned at a distance from each other or at least partially superimposed without altering the said markers.
   20. Method according to any of the previous clauses, comprising the step of scanning at least one marker via visual imaging means which comprises a filter configured to focus on the colour of at least one altered colour channel.
   21. Decorative panel, comprising an upper surface and a bottom surface, wherein at least part of the upper surface comprises at least one decorative pattern, wherein at least one marker is embedded within the decorative pattern, and wherein the colour difference Delta E between an average colour of at least one marker and an average colour of at least one region adjacent to said at least one marker is smaller than 6.
   22. Panel according to clause 21, wherein the panel is made via the method according to any of clause 1-20.
   23. Panel according to clause 21 or clause 22, wherein the Delta E between an average colour of at least one marker and an average colour of at least one region adjacent to said at least one marker is smaller than 15, more preferably smaller than 6.
   24. Panel according to clause 23, wherein the average colour of at least one marker is defined over a surface area defined by said at least one marker and wherein the average colour of at least one region adjacent to said at least one marker is at least equal in size as the surface area defined by said at least one marker.
   25. Panel according to clause 22 and/or 23, wherein the at least one region adjacent to said at least one marker substantially surrounds the at least one marker.
   26. Panel according to any of clauses 21-25, wherein at least one marker comprises a plurality of dots and/or pixels, in particular oversized pixels.
   27. Panel according to clause 26, wherein the size of at least one dot and/or pixel and preferably of multiple dots and/or pixels is at least 1×1 mm.
   28. Panel according to clause 26 and/or 27, wherein the surface area defined by at least one dot and/or pixel and preferably of multiple dots and/or pixels is at least 1 mm².
   29. Panel according to any of clauses 21-28, wherein the surface area defined by at least one marker is at least 10 mm², preferably at least 20 mm², more preferably at least 40 mm².
   30. Panel according to any of clauses 21-29, comprising at least one chamfer, and wherein at least one marker is positioned upon the at least one chamfer.
   31. Panel according to any of clauses 21-30, wherein at least one marker comprises a QR code, a data matrix, an Aztec code, a MaxiCode, and/or a DotCode.
   32. Panel according to any of clauses 21-31, wherein at least part of the decorative pattern comprises a wood pattern and wherein at least one marker is located adjacent to at least one growth ring and/or at least one knot or wherein at least one marker is located at least partially within at least one growth ring and/or at least one knot.

33. Panel according to any of clauses 21-32, wherein at least one marker is configured such that said at least one marker is detectable with visual imaging means which comprises a digital filter configured to focus on the colour of the at least one altered colour channel.

34. Panel according to any of clauses 21-33, wherein multiple markers are embedded within the decorative pattern, wherein at least two markers are positioned at a distance from each other.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A method for producing a decorative building panel comprising at least one embedded marker, comprising the steps of:
providing at least one panel comprising an upper surface and a bottom surface;
providing at least one decorative pattern comprising at least one colour model, said colour model comprising a plurality of colour channels;
manipulating at least one combination of pixels in at least one colour channel of the at least one colour model of said decorative pattern according to at least one embedding key to form a manipulated decorative pattern, wherein the at least one combination of pixels forms at least one marker;
printing at least part of the manipulated decorative pattern upon at least part of the upper surface of the at least one panel such that at least one marker is embedded within the at least one printed decorative pattern by means of at least one embedding key;
wherein the at least one embedding key defines at least one predefined colour shift in at least one colour channel of said at least one colour model.

2. The method according to claim 1, wherein the at least one embedding key comprises instructions for manipulating said at least one combination of pixels in at least one colour channel of the at least one colour model in at least one predetermined region such that the at least one marker is embedded within the printed manipulated decorative pattern.

3. The method according to claim 1, comprising the step of determining at least one region within the decorative pattern for applying said at least one marker preferably via at least one neural network.

4. The method according to claim 1, wherein the at least one marker is a colour marker.

5. The method according to claim 1, wherein the at least one colour value of the at least one colour channel of the at least one colour model of said at least one combination of pixels is increased or decreased based on the at least one embedding key.

6. The method according to claim 1, wherein said at least one combination of pixels of at least one colour channel of at least one colour model is adjusted such that the Delta E between an average colour of at least one marker and an average colour of at least one region adjacent to said at least one marker is smaller than 6.

7. The method according to claim 6, wherein the average colour of the at least one marker is defined over a surface area defined by said at least one marker and wherein the average colour of at least one region adjacent to said at least one marker is at least equal in size as the surface area defined by said at least one marker.

8. The method according to claim 1, wherein the at least one marker comprises a plurality of dots and/or pixels, wherein the surface area defined by the plurality of dots and/or pixels is at least 1 mm².

9. The method according to claim 1, wherein the at least one panel comprises at least one chamfer, and wherein at least one marker is positioned upon the at least one chamfer.

10. The method according to claim 1, comprising the step of determining the shape of at least one marker based upon the visual design of the decorative pattern.

11. The method according to claim 1, wherein at least part of the decorative pattern comprises a wood pattern and wherein at least one marker is located adjacent to at least one growth ring and/or at least one knot or wherein at least one marker is located at least partially within at least one growth ring and/or at least one knot.

12. The method according to claim 1, wherein at least part of the decorative pattern is printed upon at least part of the upper surface of at least one panel via continuous printing, digital printing, rotogravure printing, and/or combination thereof.

13. The method according to claim 1, wherein the predefined decorative pattern is unaltered.

14. The method according to claim 1, wherein at least one embedding key is included in at least a portion of at least one colour channel of at least one colour model prior to the printing step such that multiple markers are embedded within the printed decorative pattern, wherein at least two markers are positioned at a distance from each other or at least partially superimposed without altering the said markers.

15. The method according to claim 1, comprising the step of scanning at least one marker via visual imaging means which comprises a filter configured to focus on the colour of at least one altered colour channel.

16. A decorative panel, comprising an upper surface and a bottom surface, wherein at least part of the upper surface comprises at least one decorative pattern, wherein at least one marker is embedded within the decorative pattern, and wherein the colour difference Delta E between an average colour of at least one marker and an average colour of at least one region adjacent to said at least one marker is smaller than 6.

17. The panel according to claim 16, wherein the Delta E between an average colour of at least one marker and an average colour of at least one region adjacent to said at least one marker is smaller than 6 and wherein the average colour of at least one marker is defined over a surface area defined by said at least one marker and wherein the average colour of at least one region adjacent to said at least one marker is at least equal in size as the surface area defined by said at least one marker and wherein the at least one region adjacent to said at least one marker substantially surrounds the at least one marker.

18. The panel according to claim 16, wherein at least one marker comprises a plurality of dots and/or pixels, wherein the surface area defined by of the plurality of dots and/or pixels is at least 1 mm².

19. The panel according to claim 16, comprising at least one chamfer, and wherein at least one marker is positioned upon the at least one chamfer.

20. The panel according to claim 16, wherein at least part of the decorative pattern comprises a wood pattern and wherein at least one marker is located adjacent to at least one growth ring and/or at least one knot or wherein at least one marker is located at least partially within at least one growth ring and/or at least one knot.
